(19) United States
(12) Patent Application Publication
(10) Pub. No.: US 2023/0076491 A1
(43) Pub. Date: Mar. 9, 2023

(54) BATTERY PACK AND ELECTRONIC DEVICE

(71) Applicant: MURATA MANUFACTURING CO., LTD., Kyoto (JP)

(72) Inventors: Masashi SATO, Kyoto (JP); Ken SATO, Kyoto (JP); Kenichi OZAWA, Kyoto (JP); Fumio MATUMOTO, Kyoto (JP)

(21) Appl. No.: 17/988,403

(22) Filed: Nov. 16, 2022

Related U.S. Application Data
(63) Continuation of application No. PCT/JP2021/017518, filed on May 7, 2021.

(30) Foreign Application Priority Data
May 21, 2020 (JP) 2020-088609

(51) Int. Cl. H01M 50/172; H01M 50/287; H01M 50/474; H01M 50/119

(52) U.S. Cl. CPC H01M 50/172; H01M 50/287; H01M 50/474; H01M 50/119

(57) ABSTRACT

Disclosed is a battery pack including a secondary battery and a circuit board, in which the secondary battery includes a metal exterior portion, a first external terminal, and a second external terminal, the circuit board has a plurality of connection portions connected to the first external terminal or the second external terminal, at least one of the connection portions has a first opening, and the connection portion having the first opening is solder-bonded to the first external terminal or the second external terminal.

### CROSS REFERENCE TO RELATED APPLICATIONS

The present application is a continuation of PCT patent application no. PCT/JP2021/017518, filed on May 7, 2021, which claims priority to Japanese patent application no. JP2020-088609, filed on May 21, 2020, the entire contents of which are incorporated herein by reference.

### BACKGROUND

The present application relates to a battery pack and an electronic device.

A battery in which a configuration for deriving an output of the battery is connected to a positive electrode terminal or a negative electrode terminal by various methods is known. For example, a battery is described in which a negative electrode lead plate is welded to a negative electrode terminal of a coin-type lithium battery.

### SUMMARY

The present application relates to a battery pack and an electronic device.

In a battery described in the Background section, since the negative electrode lead plate is directly welded to the negative electrode terminal, the coin-type lithium battery may be damaged by heat during welding.

Therefore, the present application relates to providing a battery pack and an electronic device having a configuration in which a tab for deriving an output of a battery can be effectively joined to a positive electrode terminal or a negative electrode terminal according to an embodiment.

The present application is a battery pack including a secondary battery and a circuit board, in which the secondary battery includes a metal exterior portion, a first external terminal, and a second external terminal, the circuit board has a plurality of connection portions connected to the first external terminal or the second external terminal, at least one of the connection portions has a first opening, and the connection portion having the first opening is solder-bonded to the first external terminal or the second external terminal.

The present application may be an electronic device including the battery pack described above according to an embodiment.

According to an embodiment, the tab for deriving the output of the battery can be effectively joined to the positive electrode terminal or the negative electrode terminal. The contents of the present application should not be interpreted as being limited by the effects exemplified in the present specification.

### BRIEF DESCRIPTION OF THE FIGURES

FIG. 1 is an exploded perspective view of a battery pack according to an embodiment.

FIG. 2 is a view illustrating an appearance example of a secondary battery according to an embodiment.

FIG. 3 is a view referred to an internal configuration example of the secondary battery according to an embodiment.

FIG. 4 is a view referred to a configuration example of an FPC according to an embodiment.

FIG. 5 is a half sectional view of the battery pack according to an embodiment.

FIG. 6 is an enlarged view of a partial section of the battery pack according to an embodiment.

FIG. 7 is a view referred to an example of a method of manufacturing the battery pack according to an embodiment.

FIG. 8 is a view referred to an example of the method of manufacturing the battery pack according to an embodiment.

FIG. 9 is a view referred to an example of the method of manufacturing the battery pack according to an embodiment.

FIG. 10 is a view referred to a control example of a heat chip according to an embodiment.

FIG. 11 is view for a modification according to an embodiment.

FIG. 12 is view for a modification according to an embodiment.

FIG. 13 is view for a modification according to an embodiment.

FIG. 14 is a view for an application example according to an embodiment.

FIG. 15 is a view for an application example according to an embodiment.

### DETAILED DESCRIPTION

Hereinafter, one or more embodiments of the present application will be described in further detail including with reference to the drawings.

One or more embodiments described herein are examples of the present application, where the present application is not limited to such description.

The members shown in the claims are not specified as the members of one or more embodiments. In particular, unless otherwise specified, descriptions of dimensions, materials, shapes, relative arrangements, and directions such as up, down, left, and right of the constituent members described in one or more embodiments are not intended to limit the scope of the present application thereto, but are merely illustrative examples. Note that sizes, positional relationships, and the like of members illustrated in the drawings may be exaggerated for clarity of description, and there are cases where only a part of reference numerals may be illustrated or some of the illustrations may be simplified to prevent complication of illustration. Furthermore, in the following description, the identical names and reference numerals indicate the identical members or members of the same nature, and redundant description thereof will be omitted as appropriate. Furthermore, each element constituting the present application may be achieved in an aspect in which a plurality of elements include the identical member and one member serves as the plurality of elements, or conversely, can be achieved with a function of one member being shared by a plurality of members.

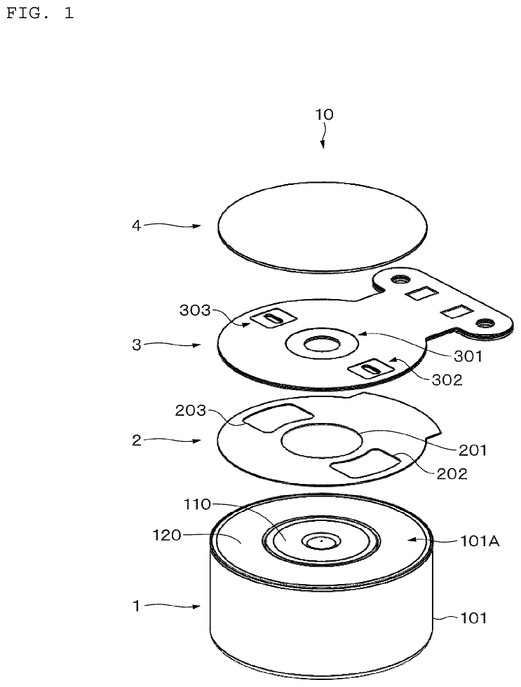

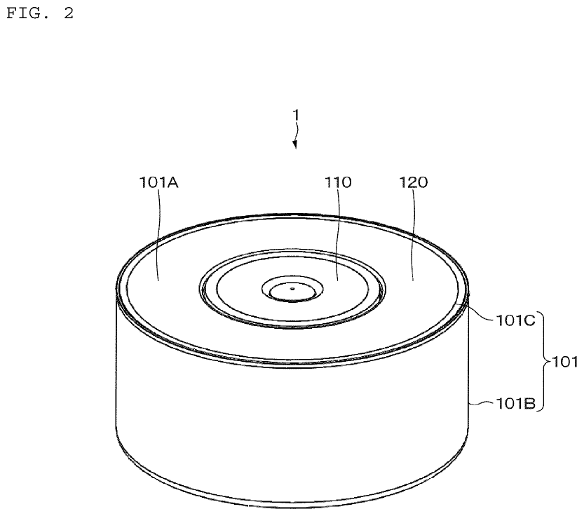

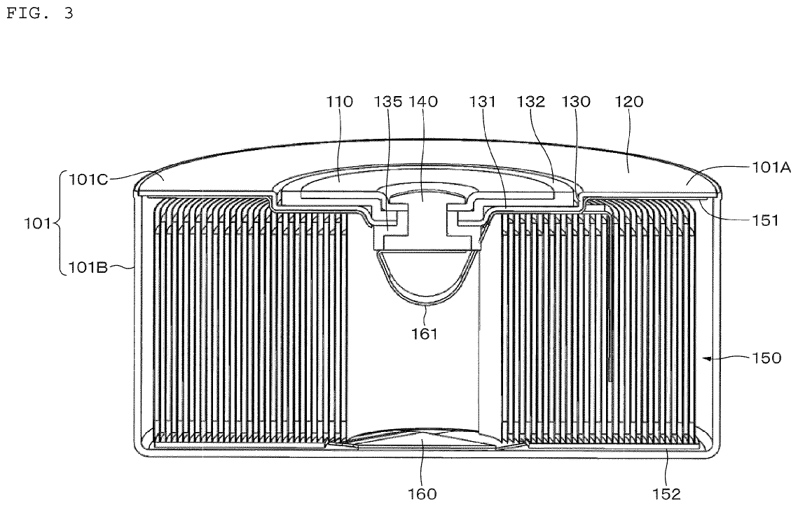

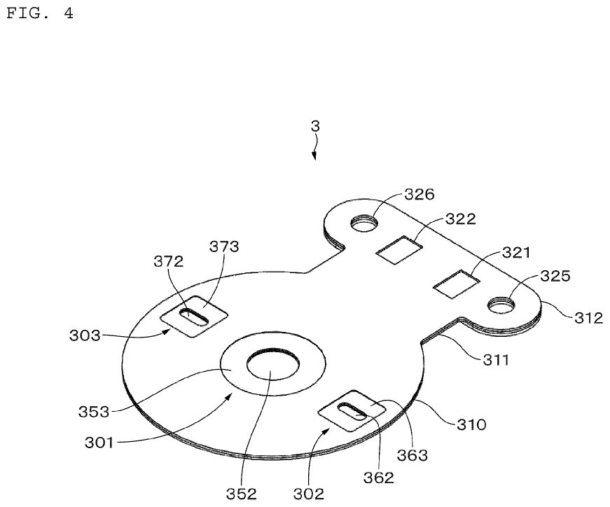

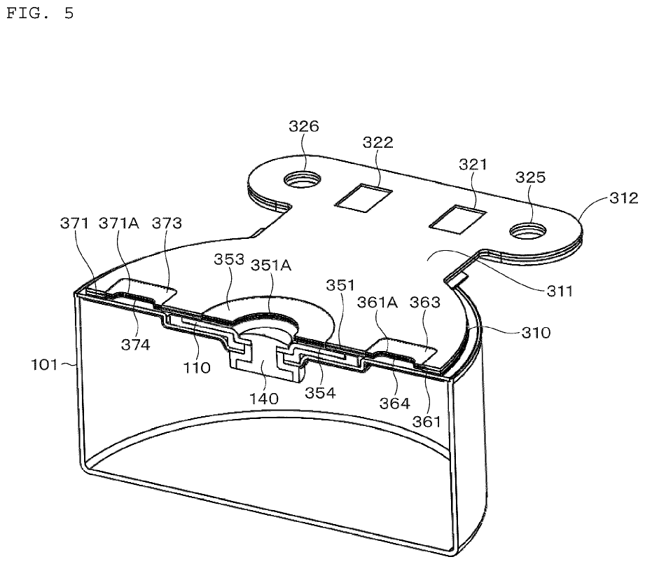

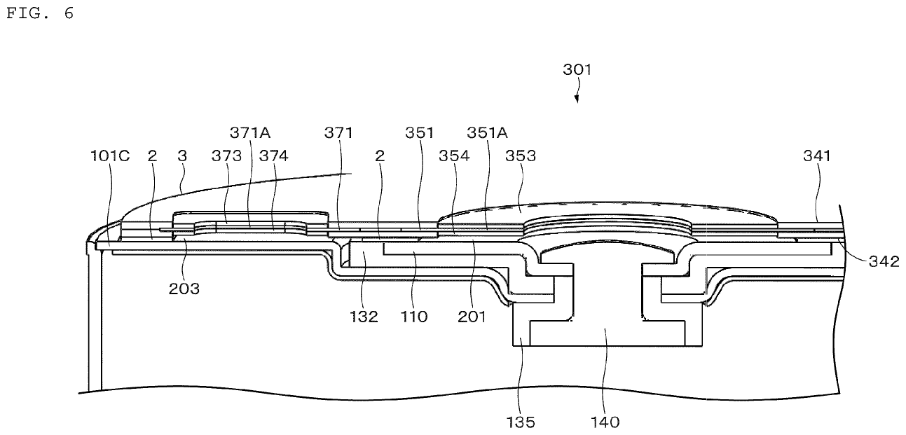

A configuration example of a battery pack according to an embodiment will be described with reference to FIGS. 1 to 6. FIG. 1 is an exploded perspective view of the battery pack according to an embodiment. FIG. 2 is a view illustrating an appearance example of a secondary battery according to an embodiment. FIG. 3 is a view referred to when an internal configuration example of the secondary battery according to an embodiment is explained. FIG. 4 is a view referred to when a configuration example of an FPC according to an embodiment is explained. FIG. 5 is a half sectional view of a battery pack according to an embodiment. FIG. 6 is an enlarged view of a partial section of the battery pack according to an embodiment. In the present specification, the battery pack refers to a battery pack having a configuration in which a circuit board is connected to a secondary battery.

As illustrated in FIG. 1, a battery pack (battery pack 10) according to an embodiment includes a secondary battery 1, a first insulating paper 2 which is an example of an insulating member, an FPC 3 which is an example of a circuit board, and a second insulating paper 4. The secondary battery 1 has a metal exterior portion 101 having a columnar shape. The first insulating paper 2, the FPC 3, and the second insulating paper 4 are sequentially stacked on an end surface 101A which is one end surface (upper surface in FIG. 1) of the metal exterior portion 101 and connected by an appropriate method, whereby the battery pack 10 according to an embodiment is completed (see FIG. 5).

A positive electrode terminal 110 which is an example of a first external terminal is disposed at the center portion (portion near the center) of the end surface 101A of the metal exterior portion 101. A negative electrode terminal 120, which is an example of a second external terminal, is disposed so as to surround a periphery of the positive electrode terminal 110.

The first insulating plate 2 has a size slightly smaller than the end surface 101A of the metal exterior portion 101, and has a substantially circular shape as a whole. As the first insulating plate 2, a polyimide (PI) film or a nonwoven fabric can be used. When a nonwoven fabric is used, a nonwoven fabric containing aramid fibers is more preferable from the viewpoint of insulating properties and flame retardancy. The first insulating paper 2 has a circular opening 201 provided at the center and rectangular openings 202 and 203 provided around the opening 201. The first insulating paper 2 is attached to the end surface 101A of the metal exterior portion 101 by adhesion or the like. In an embodiment, the opening 201 is provided at a position corresponding to an opening 352 described later. The opening 202 is provided at a position corresponding to an opening 362 described later, and the opening 203 is provided at a position corresponding to an opening 372 described later. These openings 201, 202, and 203 correspond to an example of a second opening.

The FPC 3 has a plurality of connection portions connected to the positive electrode terminal 110 or the negative electrode terminal 120. Specifically, the FPC 3 includes a connection portion 301 provided at a central portion of the end surface 101A and connection portions 302 and 303 arranged to surround a periphery of the connection portion 301. The connection portion 301 is connected to the positive electrode terminal 110 through the opening 201. The connection portion 302 is connected to the negative electrode terminal 120 through the opening 202. The connection portion 303 is connected to the negative electrode terminal 120 through the opening 203. In an embodiment, the connection portion 301 corresponds to the first connection portion, and the connection portions 302 and 303 correspond to the second connection portion.

A second insulating plate 4 covers at least a part of a surface of the FPC 3 opposite to a surface in contact with the first insulating plate 2. Specifically, the second insulating plate 4 has a size enough to cover the connection portions 301, 302, and 303, and has a circular shape. Since the connection portion 301 connected to the positive electrode terminal 110 and the connection portions 302 and 303 connected to the negative electrode terminal 120 are concealed by the second insulating plate 4, safety of the battery pack 10 can be secured. As the second insulating plate 4, a polyimide film or a nonwoven fabric can be used. When a nonwoven fabric is used, a nonwoven fabric containing aramid fibers is more preferable from the viewpoint of insulating properties and flame retardancy.

Next, details of the secondary battery 1 according to an embodiment will be described. As described above, the secondary battery 1 has the metal exterior portion 101. As illustrated in FIG. 2, the metal exterior portion 101 includes, for example, the hollow cylindrical metal exterior portion 101B whose upper side is opened and a lid-like metal exterior portion 101C disposed at an open end of the metal exterior portion 101B. The metal exterior portion 101C forms the end surface 101A described above. For example, a peripheral edge of the metal exterior portion 101B and a peripheral edge of the metal exterior portion 101C are welded.

As illustrated in FIG. 3, in the metal exterior portion 101C, a step 130 is formed at a predetermined position in a direction from the peripheral edge toward the center portion, and the center portion side is a circular recess 131. A circular opening is formed at the center of the recess 131. The positive electrode terminal 110 described above is disposed in the recess 131 with an insulating member 132 interposed therebetween. The positive electrode terminal 110 and the insulating member 132 also have a circular shape, and have a circular opening at the center portion. The openings of the positive electrode terminal 110, the insulating member 132, and the recess 131 are arranged so as to lead in a vertical direction, and a rivet 140 is driven into the location of the opening and caulked. By caulking the rivet 140, the positive electrode terminal 110 has a shape slightly recessed in the vicinity of the center. The rivet 140 has an H-shaped cross section, for example. An insulating member 135 is disposed between the rivet 140 and each of the negative electrode terminal 120 and the insulating member 132.

A battery element 150 is housed in the metal exterior portion 101. A top insulator 151 is disposed on an upper side of the battery element 150, and a bottom insulator 152 is disposed on a lower side. The negative electrode side of the battery element 150 is connected to a bottom surface of the metal exterior portion 101B with a negative electrode lead 160 interposed therebetween by welding or the like. With such connection, the entire metal exterior portion 101 has a negative polarity and functions as the negative electrode terminal 120. The positive electrode side of the battery element 150 is connected to a lower side of the rivet 140 with a positive electrode lead 161 interposed therebetween for welding. With such connection, the positive electrode terminal 110 abutted against the rivet 140 has a positive polarity.

As the positive electrode terminal 110, for example, a nickel plate can be used. As the metal exterior portion 101 functioning as the negative electrode terminal 120, a stainless steel exterior portion in which the location of the end surface 101A is plated with nickel can be used. As a material of the rivet 140, for example, aluminum can be used. These materials are examples, and are not limited to the exemplified materials.

The terminal in the positive electrode terminal or the negative electrode terminal in the present specification is not limited to a physical contact, and may have a configuration having positive or negative polarity. For example, the terminal may have a case shape as in the metal exterior portion 101 in an embodiment.

### (FPC)

Next, details of the FPC 3 according to an embodiment will be described. As illustrated in FIGS. 4 and 5, the FPC 3 includes a circular base portion 310, a rectangular intermediate portion 311 extending from a predetermined peripheral edge of the base portion 310, and a long elliptical distal end portion 312 located at a distal end of the intermediate portion 311, and has a configuration in which these portions are integrally formed.

The connection portion 301 described above is formed at the center portion of the base portion 310. The above-described connection portions 302 and 303 are formed around the connection portion 301 provided at the base portion 310. As described above, the connection portions 301, 302, and 303 are arranged in the same plane.

A connection terminal such as a copper plate connected to an external device is formed at the distal end portion 312. For example, the connection terminal 321 and the connection terminal 322 are formed at the distal end portion 312. As described above, the connection terminal 321 and the connection terminal 322 are provided on the same substrate as the FPC3.

The connection terminal 321 is connected to the connection portion 301 by a predetermined pattern. The connection terminal 321 functions as an output terminal on the positive electrode side. The connection terminal 322 is connected to at least one of the connection portion 302 and the connection portion 303 by a predetermined pattern. The connection terminal 322 functions as an output terminal on the negative electrode side. A connector may be provided at the distal end portion 312. A circular hole 325 and a hole 326 are formed near both ends of the distal end portion 312. The hole 325 and the hole 326 are holes for positioning the secondary battery 1 and the FPC 3. For example, by inserting a pin-shaped jig into the hole 325 and the hole 326, the secondary battery 1 and the FPC 3 are positioned.

As illustrated in FIG. 6, the FPC 3 includes, for example, polyimide sheets 341 and 342 stacked in two layers. The connection portion 301 includes a tab 351. As the tab 351, a copper foil, a nickel tab, or the like can be used. The tab 351 has the circular opening 352 (see FIG. 4) at a central portion. The vicinity of a peripheral edge of the tab 351 is sandwiched and supported by the polyimide sheets 341 and 342. The tab 351 includes a tab 351A as a metal exposed portion. The tab 351A is an exposed portion of the tab 351, that is, a portion not sandwiched between the polyimide sheets 341 and 342. The opening 352 described above is formed by an inner peripheral edge of the tab 351A. In other words, the tab 351A surrounds a periphery of the opening 352.

As illustrated in FIGS. 4 and 6, preliminary solder 353 is provided on an upper side of the tab 351A, and preliminary solder 354 is provided on the lower side. The preliminary solder means a small amount of solder provided in advance on a portion to be soldered in order to improve solderability, and for example, a low melting point solder paste is used.

The connection portion 302 includes a tab 361. As the tab 361, a copper foil, a nickel tab, or the like can be used. The tab 361 has the long elliptical opening 362 (see FIG. 4) at a central portion. The vicinity of a peripheral edge of the tab 361 is sandwiched and supported by the polyimide sheets 341 and 342. As illustrated in FIG. 5, the tab 361 has a tab 361A as a metal exposed portion. The tab 361A is an exposed portion of the tab 361, that is, a portion not sandwiched between the polyimide sheets 341 and 342. The opening 362 described above is formed by an inner peripheral edge of the tab 361A. In other words, the tab 361A surrounds a periphery of the opening 362. As illustrated in FIG. 5, preliminary solder 363 is provided on an upper side of the exposed portion of the tab 361A, and preliminary solder 364 is provided on the lower side.

The connection portion 303 includes a tab 371. As the tab 371, a copper foil, a nickel tab, or the like can be used. The tab 371 has the long elliptical opening 372 (see FIG. 4) at a central portion. The vicinity of a peripheral edge of the tab 371 is sandwiched and supported by the polyimide sheets 341 and 342. As illustrated in FIG. 6, the tab 371 has a tab 371A as a metal exposed portion. The tab 371A is an exposed portion of the tab 371, that is, a portion not sandwiched between the polyimide sheets 341 and 342. The opening 372 described above is formed by an inner peripheral edge of the tab 371A. In other words, the tab 371A surrounds the periphery of the opening 362. As illustrated in FIGS. 4 and 6, preliminary solder 373 is provided on an upper side of the exposed portion of the tab 371, and preliminary solder 374 is provided on the lower side. As described above, the second connection portion (for example, the connection portions 302 and 303) has the plurality of metal exposed portions (for example, tabs 361A and 371 A).

In an embodiment, at least one of the openings 352, 362, and 372 corresponds to the first opening.

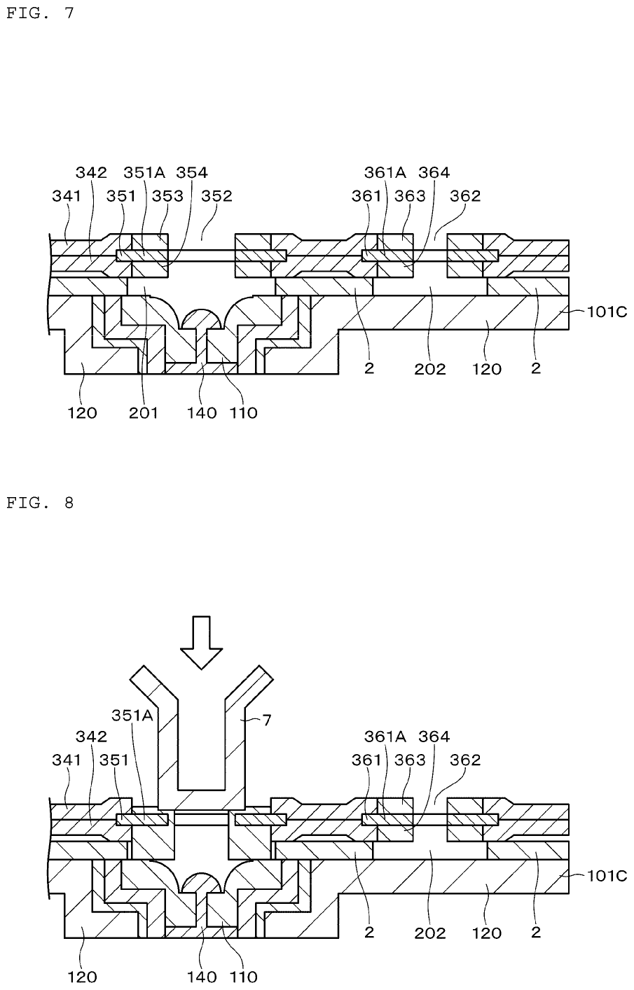

Next, an example of a method of manufacturing the battery pack 10 will be described with reference to FIGS. 7 to 9. FIGS. 7 to 9 illustrate some configurations in a simplified manner as appropriate. First, the first insulating plate 2 is attached to the end surface 101A of the secondary battery 1 by adhesion or the like. Then, for example, by inserting a pin-shaped jig into the hole 325 and the hole 326, the FPC 3 is positioned. As illustrated in FIG. 7, in a state where the FPC 3 is positioned, the opening 352 communicates with the opening 201 of the first insulating plate 2, and a tip of the rivet 140 is visible through the communicating portion. A bottom surface of the preliminary solder 354 and a flat portion of the positive electrode terminal 110 face each other with a facing gap corresponding to the thickness of the first insulating plate 2. In addition, in the state where the FPC 3 is positioned, the opening 362 communicates with the opening 202 of the first insulating plate 2, and a part of the metal exterior portion 101C is visible through the communicating portion. A bottom surface of the preliminary solder 364 and a part of the metal exterior portion 101C face each other with the facing gap corresponding to the thickness of the first insulating plate 2. Although not illustrated, in the state where the FPC 3 is positioned, the opening 372 communicates with the opening 203 of the first insulating plate 2, and a part of the metal exterior portion 101C is visible through the communicating portion. A bottom surface of the preliminary solder 374 and a part of the metal exterior portion 101C face each other with the facing gap corresponding to the thickness of the first insulating plate 2.

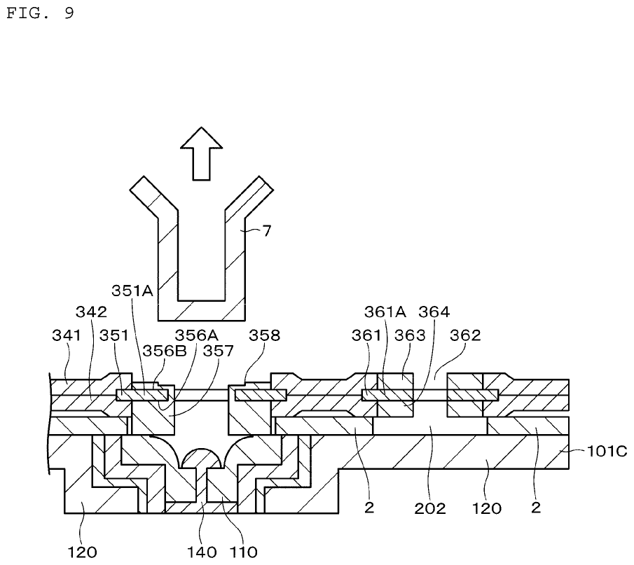

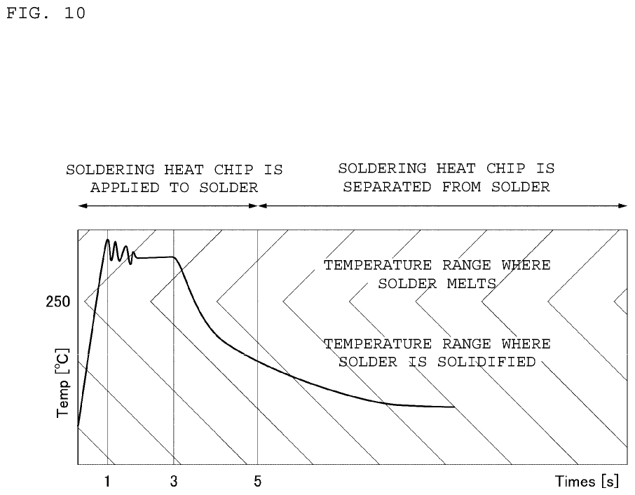

In the state where the FPC 3 is positioned, as illustrated in FIG. 8, for example, a heat chip 7 is pressed against the location of the preliminary solder 353. As a result, the preliminary solder 353 is melted, and, in addition, the heat of the heat chip propagates to the preliminary solder 354 on the lower side to melt the preliminary solder 354. The molten solder flows downward. As illustrated in FIG. 9, after a certain period of time, the heat chip is separated, and the molten solder is solidified. As a result, the tab 351 and the positive electrode terminal 110 are solder-bonded.

After the solder bonding, a solder portion is formed on at least a part of a surface of the tab 351A. In an embodiment, a solder portion is formed on the entire surface of the tab 351A. Specifically, as illustrated in FIG. 9, a solder portion 357 is formed from a surface 356A of the tab 351A facing the secondary battery 1 to an opposite surface 356B. In addition, a step 358 which is a mark obtained by pressing the heat chip 7 is formed in the solder portion 357 formed on the opposite surface 356B of the tab 351A. The solder portion 357 may be formed on a part of the tab 351A.

Similarly, in the state where the FPC 3 is positioned, for example, the heat chip 7 is pressed against the location of the preliminary solder 363. Similarly to the solder bonding in the connection portion 301 described above, the tab 361A and the metal exterior portion 101C, that is, the negative electrode terminal 120 are solder-bonded. Thus, a solder portion is formed across both surfaces of the tab 361A. In addition, a step which is a mark obtained by pressing the heat chip 7 is formed in the solder portion formed on an opposite surface of the tab 361A.

Similarly, in the state where the FPC 3 is positioned, for example, the heat chip 7 is pressed against the location of the preliminary solder 373. Similarly to the solder bonding in the connection portion 301 described above, the tab 371A and the metal exterior portion 101C, that is, the negative electrode terminal 120 are solder-bonded. Thus, a solder portion is formed across both surfaces of the tab 371A. In addition, a step which is a mark obtained by pressing the heat chip 7 is formed in the solder portion formed on an opposite surface of the tab 371A.

In the state illustrated in FIG. 5, that is, after the solder bonding is completed, the second insulating plate 4 is attached to an upper surface of the FPC 3 by adhesion or the like. As described above, the battery pack 10 is completed.

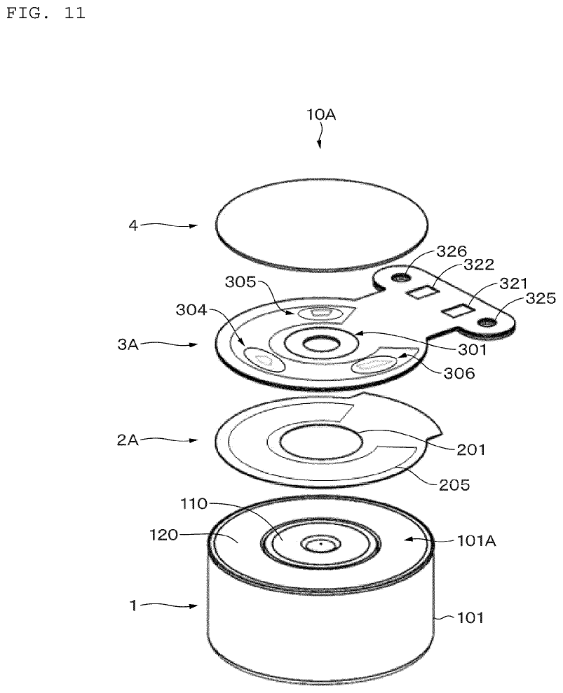

An operation control example of the heat chip 7 will be described with reference to FIG. 10. In FIG. 10, the horizontal axis represents time (seconds), and the vertical axis represents the temperature of the heat chip 7. The melting temperature of the preliminary solder is set to 250° C. The heat chip 7 is energized in a state where the heat chip 7 is pressed against the preliminary solder (for example, the preliminary solder 353). As illustrated in FIG. 10, the temperature of the heat chip 7 becomes 250° C. or higher in less than about 1 second, and the preliminary solders 353 and 354 are melted. Then, the energization is stopped in about 2 seconds (after 3 seconds). As a result, the temperature of the heat chip 7 is lowered to 250° C. or lower, and the molten solder is solidified to form the solder portion 357. For example, when about 5 seconds have elapsed, the heat chip 7 is separated from the solder portion 357. By separating the heat chip 7 after the solder is solidified to form the solder portion 357, it is possible to prevent the solder from being peeled off due to surface tension, and to realize reduction in height of the solder portion 357 (low height).

The preliminary solder is preferably formed above and below the metal exposed portion. If the preliminary solder is formed only on the lower side of the metal exposed portion, heat of the heat chip 7 is less likely to be transferred to the preliminary solder, so that it is necessary to press the heat chip 7 for a long period of time. As a result, the heat of the heat chip 7 is transferred to the secondary battery 1 for a long time, which may damage the secondary battery 1. When the preliminary solder is formed above and below the metal exposed portion, the upper solder melts, and heat is transferred to the metal exposed portion, so that the lower preliminary solder can be quickly melted.

As described above, the connection portion 301 is connected to the connection terminal 321 by a predetermined pattern. As a result, the output on the positive electrode side can be output to the outside via the connection portion 301 and the connection terminal 321 solder-bonded to the positive electrode terminal 110. At least one of the connection portion 302 and the connection portion 303 is connected to the connection terminal 322 by a predetermined pattern. As a result, the output on the negative electrode side can be output to the outside via at least one of the connection portions 302 and 303 solder-bonded to the negative electrode terminal 120 and the connection terminal 322. The intermediate portion 311 of the FPC 3 may be bent when the connection terminals 321 and 322 are connected to an external device.

When the connection portion 301 is connected to the positive electrode terminal 110, molten solder flows so that the connection portion 301 is also solder-bonded to the negative electrode terminal 120, which may cause short-circuiting. On the other hand, when the connection portions 302 and 303 are connected to the negative electrode terminal 120, molten solder flows so that the connection portions 302 and 303 are solder-bonded to the positive electrode terminal 110, which may cause short-circuiting. However, in an embodiment, the first insulating plate 2 is disposed each of between the connection portion 301 and the connection portion 302 and between the connection portion 301 and the connection portion 303. Therefore, it is possible to prevent the occurrence of short-circuiting due to the molten solder flowing to the other electrode side.

According to an embodiment, the following effects can be obtained.

The tab of the FPC and the secondary battery (cell) can be effectively metal-bonded by solder. Therefore, higher mechanical bonding strength is obtained as compared with bonding with a conductive epoxy resin. In addition, a total resistance value as the battery pack can also be reduced.

Preliminary solder is provided on both surfaces or one surface of the metal exposed portion of the FPC, and it is possible to perform soldering in which the height of the solder is suppressed to be low by a soldering heat chip whose temperature (heating/temperature decreasing time), pressurization, and height are controlled. As a result, it is possible to prevent the height of the solder from increasing due to the surface tension of the solder, and it is possible to reduce the height.

In an embodiment, the preliminary solder on the lower side of the metal exposed portion is disposed so as to face the flat portion of the positive electrode terminal or the negative electrode terminal. As a result, heat in solder bonding is easily transferred uniformly, and occurrence of solder bonding failure can be prevented.

Each connection portion of the FPC has the opening communicating with the opening of the first insulating plate. As a result, at the time of solder bonding, the metal exposed portion and the location of the preliminary solder can be easily bent by pressurization of the heat chip. As a result, the lower preliminary solder is easily abutted against the positive electrode terminal, and the solder bonding can be reliably performed.

In addition, the area of soldering can be reduced by the opening of each connection portion, and thermal damage to the secondary battery can be reduced.

With the configuration in which the preliminary solder is provided on both surfaces of the metal exposed portion of the FPC, the preliminary solder on the upper side of the metal exposed portion melts during soldering, so that heat can be efficiently transferred to the metal exposed portion and the preliminary solder on the lower side of the metal exposed portion. Therefore, it is possible to perform soldering in a short time. In addition, since the cross section of the solder portion covers the end surface of the metal exposed portion and has an H-shaped cross section like a through hole of the substrate, mechanical strength of soldering can be increased.

In addition, since each connection portion has the opening, whether or not the lower solder on the metal exposed portion is reliably melted and firmly attached to a soldering surface can be confirmed via the opening after the soldering is finished. That is, the opening can be used as an inspection window.

In the structure in which the positive electrode/negative electrode terminal is connected to the FPC on the same surface as in an embodiment, the size of the FPC itself can be made compact, and the dimension of the battery pack can be minimized.

As in an embodiment, with the structure in which the positive electrode/negative electrode terminal is connected to the FPC 3 and taken out from the same surface of the secondary battery, it is not necessary to flip the secondary battery, so that assembly operability in the manufacturing process can be improved.

In an embodiment, since the positive electrode/negative electrode terminals are collectively taken out from the same surface of the secondary battery via the FPC, insulation can be performed only by the insulating plate on the upper surface of the FPC.

Since short-circuiting does not occur while the side surface and the bottom surface of the secondary battery are exposed, the number of components can be reduced, and the outer dimension of the compact battery pack can be realized.

An embodiment of the present application has been specifically described above; however, the contents of the present application are not limited thereto, and various modifications of the present application. Similarly to the configuration described in an embodiment, the same reference numerals are given to the same configurations, and redundant description is appropriately omitted.

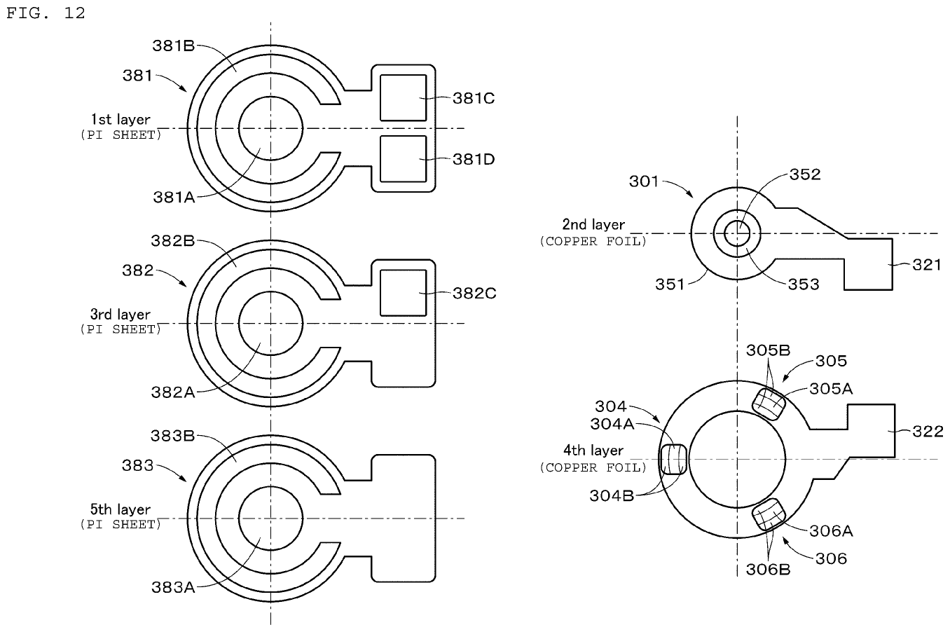

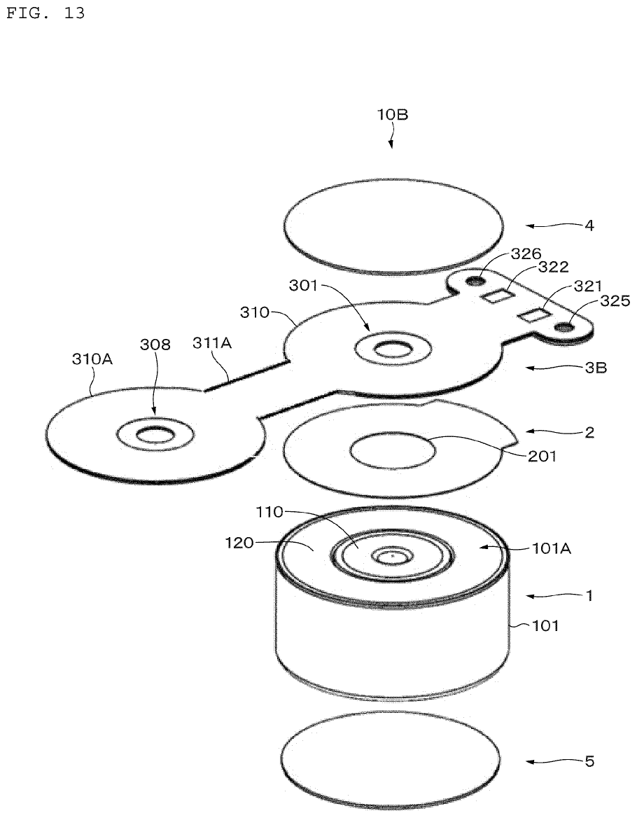

Next, a battery pack 10A according to a modification will be described with reference to FIGS. 11 and 12. As illustrated in FIG. 11, unlike the battery pack 10, the battery pack 10A includes a first insulating plate 2A and an FPC 3A. The first insulating plate 2A has the opening 201 at a central portion and has a C-shaped opening 205 formed around the opening 201. The FPC 3A has the connection portion 301 at a central portion, and has connection portions 304, 305, and 306 formed to surround the periphery of the connection portion 301.

FIG. 12 is a diagram illustrating a configuration example of the FPC 3A. The FPC 3A has a configuration in which five layer configurations are stacked. A first layer, a third layer, and a fifth layer are PI sheets, and a second layer and a fourth layer are copper foils. A PI sheet 381 which is the first layer has an opening 381A formed at a central portion of a base portion and an opening 381B formed around the opening 381A, and has two rectangular openings 381C and 381D at a location of a tip portion. A PI sheet 382 which is the third layer has an opening 382A formed in a central portion of a base portion, an opening 382B formed around the opening 382A, and a rectangular opening 382C at a location of a tip portion. A PI sheet 383 which is the fifth layer has an opening 383A formed at a central portion of a base portion and an opening 383B formed around the opening 383A.

The connection portion 301 which is the second layer has the tab 351 and the opening 352 as in an embodiment. The connection portion 301 further has the connection terminal 321, and has a configuration in which the tab 351 and the connection terminal 321 are formed of the same copper foil. The preliminary solders 353 and 354 are formed at portions to be metal exposed portions of the tab 351. FIG. 12 illustrates the preliminary solder 353.

The copper foil of the 4th layer has a configuration in which a circular copper foil and a copper foil constituting the connection terminal 322 are integrally formed. The connection portions 304, 305, and 306 are formed on a circular copper foil, respectively. The connection portion 304 has a rectangular opening 304A. The preliminary solder is formed above and below a portion of the connection portion 304 to be a metal exposed portion. FIG. 12 illustrates preliminary solder 304B formed on the upper side. The other connection portions have the same configuration.

The above five layers are stacked, by the same method as in an embodiment, the connection portion 301 is connected to the positive electrode terminal 110, and the connection portions 304 to 306 are connected to the negative electrode terminal 120. As a result, it is possible to achieve a layout in which one pole (for example, positive electrode terminal) is surrounded by the other pole (for example, negative electrode terminal). In addition, a plurality of locations to be bonded to the negative electrode terminal 120 can be efficiently arranged, and the mechanical bonding strength can be improved. The connection terminal 321 is exposed through an opening 381D, and the connection terminal 322 is exposed through openings 381C and 382C.

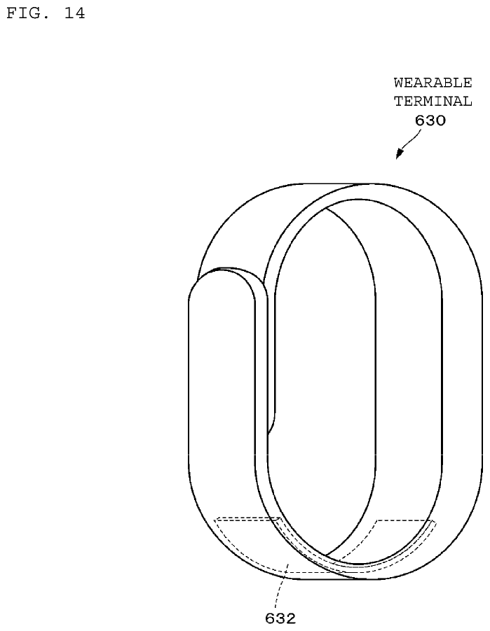

FIG. 13 is an exploded perspective view for describing a configuration example of a battery pack 10B according to a modification. The battery pack 10B has an FPC 3B and an insulating plate 5. The FPC 3B has a circular base portion 310A integrally connected to the base portion 310 with a coupling portion 311A interposed therebetween. A connection portion 308 is formed at a central portion of the base portion 310A. In the battery pack 10B, the connection portion 301 is bonded to the positive electrode terminal 110 in the same manner as described above in an embodiment. In the battery pack 10B, the coupling portion 311A is bent after the coupling portion 311A is led around along a side surface of the secondary battery 1. Then, the connection portion 308 is solder-bonded to the negative electrode terminal 120 on the bottom surface of the secondary battery 1, that is, on a surface opposite to the end surface 101A in the same manner as described above in an embodiment. After the solder bonding, the insulating plate 5 is attached.

As described above, the FPC 3B may be bonded to a different surface of the secondary battery 1. Even in this case, it is not necessary to insulate the side surface of the secondary battery 1, so that the number of components can be reduced, and the outer dimension of the battery pack 10B can be made compact.

As described above in an embodiment, it is sufficient that the location of at least one connection portion (connection portion to be solder-bonded) has an opening, and it is not necessary that all the connection portions have an opening. For example, some connection portions may be bonded to the positive electrode terminal or the negative electrode terminal by a method other than solder bonding, such as resistance welding or laser welding, and in such a case, the connection portions do not necessarily have an opening.

In the above-described, the first external terminal may be a negative electrode, and the second external terminal may be a positive electrode. Further, in the above-described, the configuration corresponding to the insulating member may be not the first insulating plate 2 but the insulating member of the FPC 3, that is, a PI film. Further, in the above-described, the circuit board may be an insulation-coated metal plate instead of the FPC 3. Furthermore, in the above-described, the rivet 140 may not be provided. The shape of the metal exterior portion 101 is not limited to the columnar shape, and may be another shape such as a prismatic shape. In addition, an IC (Integrated Circuit) that performs a known protection operation for the battery pack 10 may be mounted on the FPC 3.

The matters described above and modifications can be appropriately combined. In addition, the materials, processes, and the like described in an embodiment are merely examples, and the contents of the present application are not limited to the exemplified materials and the like.

The battery pack according to the present application can be mounted on various electronic devices such as wireless earphones, electric tools, electric vehicles, and the like, or can be used for supplying electric power.

A specific application example will be described. For example, the battery pack described above can be used as a power source for a wearable device having a function of a portable information terminal, a so-called wearable terminal. Examples of the wearable terminal include a wristwatch-type terminal and a glasses-type terminal, and are not limited thereto.

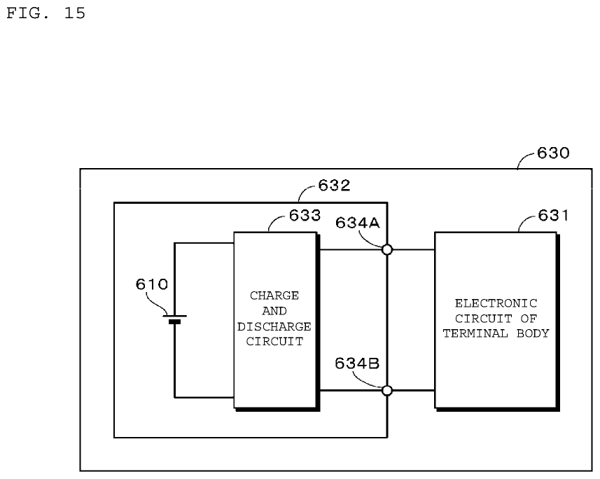

FIG. 14 illustrates an example of a wearable terminal incorporating a battery pack. As illustrated in FIG. 14, a wearable terminal 630 according to the application example is a wristwatch-type terminal, and includes a battery pack 632 therein. The battery pack according to the present application can be applied as the battery pack 632. The wearable terminal 630 can be worn and used by a user. The wearable terminal 630 may be a deformable flexible terminal.

As illustrated in FIG. 15, the wearable terminal 630 according to an application example includes an electronic circuit 631 of an electronic device body and the battery pack 632. The battery pack 632 is electrically connected to the electronic circuit 631. The wearable terminal 630 has, for example, a configuration in which the battery pack 632 is detachable by the user. The configuration of the wearable terminal 630 is not limited to this example, and the battery pack 632 may be incorporated in the wearable terminal 630 such that the user cannot remove the battery pack 632 from the wearable terminal 630.

During charging of the battery pack 632, the positive electrode terminal 634A and the negative electrode terminal 634B of the battery pack 632 are connected to a positive electrode terminal and a negative electrode terminal of a charger (not shown), respectively. On the other hand, during discharging of the battery pack 632 (during use of the wearable terminal 630), the positive electrode terminal 634A and the negative electrode terminal 634B of the battery pack 632 are connected to a positive electrode terminal and a negative electrode terminal of the electronic circuit 631, respectively.

For example, the electronic circuit 631 includes CPU, a peripheral logic unit, an interface unit, and a storage unit, and controls the overall operation of the wearable terminal 630.

The battery pack 632 includes an all-solid-state battery cell 610 (all-solid-state battery 13 in an embodiment) and a charge and discharge circuit 633.

### DESCRIPTION OF REFERENCE SYMBOLS

1: Secondary battery
2: First insulating plate
3: FPC
4: Second insulating plate
10: Battery pack
101: Metal exterior portion
110: Positive electrode terminal
120: Negative electrode terminal
201, 202, 203: Opening of second insulating plate
301, 302, 303: Connection portion
321, 322: Connection terminal
351A, 361A, 371A: Tab
352, 362, 372: Opening of each connection portion
357: Solder portion
358: Step

It should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims.

1. A battery pack comprising:
a secondary battery; and
a circuit board,
wherein the secondary battery includes a metal exterior portion, a first external terminal, and a second external terminal,
the circuit board has a plurality of connection portions connected to the first external terminal or the second external terminal, at least one of the connection portions has a first opening, and
the connection portion having the first opening is solder-bonded to the first external terminal or the second external terminal.

2. The battery pack according to claim 1, wherein the circuit board includes an FPC or an insulation-coated metal plate.

3. The battery pack according to claim 1, wherein the connection portion has a metal exposed portion surrounding a periphery of the first opening.

4. The battery pack according to claim 3, wherein a solder portion is formed on at least a part of a surface of the metal exposed portion.

5. The battery pack according to claim 4, wherein the solder portion is formed from a surface of the metal exposed portion facing the secondary battery to an opposite surface.

6. The battery pack according to claim 5, wherein the solder portion formed on an opposite surface of the metal exposed portion has a step.

7. The battery pack according to claim 1, wherein the first external terminal is disposed at a center portion of an end surface of the metal exterior portion,
the second external terminal is disposed so as to surround the first external terminal, and
a plurality of the connection portions are arranged on a same plane.

8. The battery pack according to claim 7, wherein the plurality of connection portions include a first connection portion connected to the first external terminal and a second connection portion connected to the second external terminal, and
the second connection portion is disposed so as to surround the first connection portion.

9. The battery pack according to claim 8, wherein the second connection portion has a plurality of the metal exposed portions.

10. The battery pack according to claim 1, wherein an insulating member is disposed between the circuit board and the secondary battery, and
the insulating member has a second opening at a location corresponding to the plurality of connection portions.

11. The battery pack according to claim 1, wherein the metal exterior portion has a columnar or prismatic shape.

12. An electronic device comprising the battery pack according to claim 1.
